(19) United States
(12) Patent Application Publication
(10) Pub. No.: US 2008/0113246 A1
(43) Pub. Date: May 15, 2008

(54) Arrangement And Method In A Fuel Cell Apparatus

(75) Inventors: Timo Kivisaari, Helsinki (FI); Timo Mahlanen, Helsinki (FI)

Correspondence Address: SMITH-HILL AND BEDELL, P.C., 16100 NW CORNELL ROAD, SUITE 220, BEAVERTON, OR, 97006, US

(73) Assignee: WARTSILA FINLAND OY, Vaasa (FI)

(21) Appl. No.: 11/813,200

(22) PCT Filed: Dec. 20, 2005
(86) PCT No.: PCT/FI05/50468

§ 371 Date: Jun. 29, 2007

(30) Foreign Application Priority Data
Jan. 3, 2005 (FI) 20055003

(51) Int. Cl. H01M 8/04

(52) U.S. Cl. 429/34; 429/26; 429/24; 429/13

(57) ABSTRACT

The present invention relates to an arrangement in fuel cell apparatuses for processing the leakage gases of fuel cells, the fuel cell apparatus comprising at least a fuel cell unit, the fuel cells of which include an anode side and a cathode side and an electrolyte therebetween and in which fuel cell apparatus there is at least a fuel inlet into the anode side and an oxygen-containing gas inlet into the cathode side. According to the invention the fuel cell unit is surrounded by a fire-proof casing provided with a combustion space, the combustion space of the casing being combined with an inlet for introducing oxygen-containing gas into the combustion space.

The present invention relates to an arrangement for processing the leakage gases of fuel cells in a fuel cell apparatus as described in the preamble of claim 1, the fuel cell apparatus comprising at least a fuel cell unit, the fuel cells of which include an anode side and a cathode side with the fuel cell apparatus comprising at least a fuel inlet for the anode side and an oxygen-containing gas inlet for the cathode side. The invention also relates to a method according to the preamble of claim 7.

One future energy source, having a good efficiency, is the fuel cell by means of which fuel is directly transformed to electricity via a chemical reaction. A fuel cell contains two electrodes, an anode and a cathode, between which is an ion-conducting material called the electrolyte. Usually, the used fuel is natural gas or other hydrocarbon, which must usually be converted to fuel used by the fuel cell by, for example, reforming. Thus processed, the fuel is directed to the anode of the fuel cell and the oxygen necessary for oxidizing is introduced to the cathode of the fuel cell in the form of, for example, air. In the reaction, electrons are released from the hydrogen of the fuel gas on the anode and they traverse to the cathode of the fuel cell via an external circuit, i.e. the load located subsequent to the fuel cell. Thus, hydrogen is combined with oxygen in the fuel cell, forming heat and energy, the energy being capable of being directly recovered as electric energy without the need of converting it into mechanical form. However, the potential difference created by a single fuel cell is typically so small that it is considered expedient to form a unit of a number of fuel cells connected in series, i.e. a so-called fuel cell stack, which stacks can further be connected in series or in parallel for further increasing voltage or current. The advantages of fuel cells include good efficiency, silence and very small need of moving parts. Another advantage is that being only water or water vapour, the emissions are environmentally friendly and clean.

Fuel cell stacks operating in high temperature, such as stacks formed of planar solid oxide fuel cells (SOFC) or molten carbonate fuel cells (MCFC) must be sealed with, e.g. glass and pressed tightly together for avoiding leaks. Despite this, some fuel-containing gas will always leak out of the fuel cell stacks, the gas containing hydrogen and air, whereby it is environmentally dangerous combustible gas and, in addition to this, dangerous when inhaled.

In prior art solutions the leak gas of fuel cell stacks is e.g. ventilated away directly from the apparatus by means of a continuous air flow. A disadvantage of this is the above-mentioned dangerousness and the fact that the continuous air flow cools the apparatus, whereby energy is lost and the efficiency of the apparatus is decreased.

In order to correct this disadvantage, prior art also discloses solutions, in which the fuel cell stacks are located in a closed pressure vessel. Thus, when a suitable pressure is arranged inside the pressure vessel, the pressure corresponding to the internal pressure of the fuel cell stacks, gas leaks from the fuel cell stacks can be prevented. However, a disadvantage is that pressure vessels suitable for this are large, heavy and thereby also very expensive. The pressure vessel as such can additionally be dangerous.

The aim of the invention is to produce an arrangement in a fuel cell apparatus by means of which the above-mentioned disadvantages of prior art can be eliminated. An especial aim of the invention is to produce an arrangement in fuel cell apparatuses for treating gas leaks from fuel cells so that the gas leaks do not cause environmental risks and additional danger in the vicinity of the apparatus. An additional aim of the invention is to produce an arrangement in which the fuel cell stacks can be preheated during the starting phase with afterburner exhaust gases containing excess oxygen. The arrangement according to the invention is characterized by what is disclosed in the characterizing part of claim 1. Other embodiments of the invention are characterized by what is disclosed in other claims. The invention is characterized by what is disclosed in the characterizing part of claim 7.

The basic idea of an arrangement according to the invention is that the fuel cell unit consisting of a fuel cell stack or stacks is enclosed into a combustion space of a fire-proof enclosure, into which is arranged an inlet for introducing oxygen-containing gas for combusting fuel leakages. One of the advantages is that thus the leaked hydrogen used as fuel can be safely combusted without causing environmental problems and power losses. Another advantage is that combustion of the leaked fuel, instead of causing heat loss, simultaneously allows maintaining the fuel cells in the necessary temperature, whereby the total efficiency is improved. This is preferably accomplished by arranging an inlet line from the afterburner of the system for introducing exhaust gas containing excess oxygen into the said combustion space of the enclosure. An additional advantage is thus that during the starting phase of the fuel cell apparatus the solution according to the invention allows preheating the fuel cell stacks by means of an afterburner, whereby an electrically operated preheating can be reduced or no electricity at all is needed for preheating. Another advantage is that no large, heavy, expensive and dangerous pressure vessel is needed to surround the fuel cell unit.

In a method according to the invention for processing fuel cell leakage gases in a fuel cell apparatus, the fuel cell apparatus comprising at least a fuel cell unit, the fuel cells of which include an anode side and a cathode side and an electrolyte therebetween, the fuel cell apparatus at least comprising a fuel inlet to the anode side and introduction of oxygen-containing gas into the cathode side, when using the fuel cell apparatus fuel is introduced into the anode side and oxygen-containing gas is introduced into the cathode side. A characterizing feature of the method according to the invention is that oxygen-containing gas is introduced into the space surrounding the fuel cell unit.

In the following the invention is disclosed in more detail by means of an exemplary embodiment and by reference to the appended drawings, in which

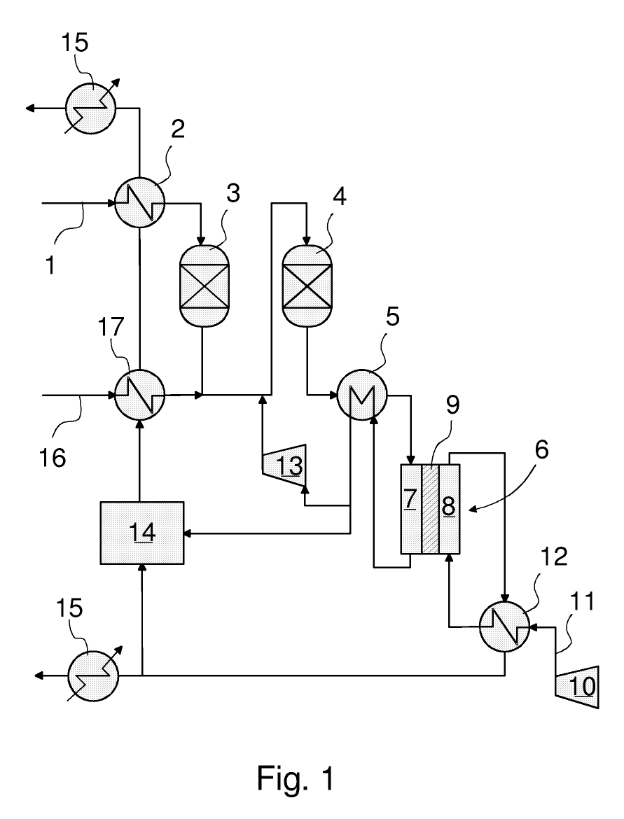

FIG. 1 shows, schematically and in a simplified way, one typical fuel cell apparatus, and

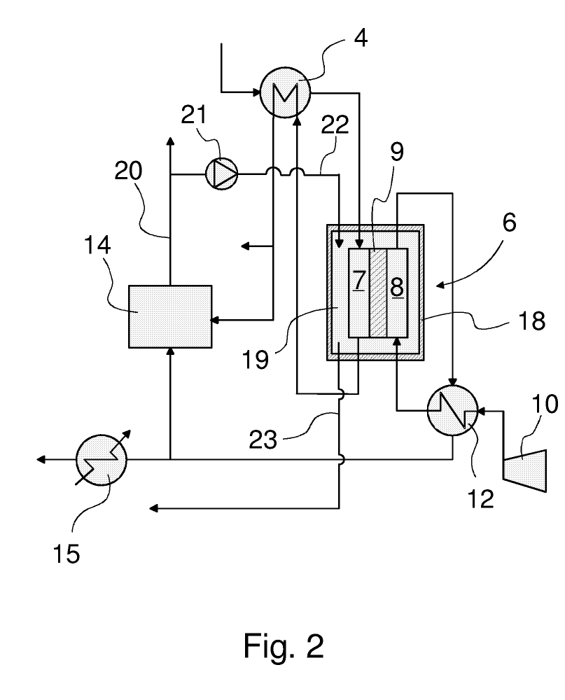

FIG. 2 shows, schematically and in a simplified way, an arrangement according to the invention being applied to a fuel cell apparatus.

FIG. 1 shows as a simplified schematic illustration a typical fuel cell apparatus, in which the arrangement according to the invention can be used. FIG. 1 shows a fuel cell apparatus, in which the high temperature fuel cell stacks forming the fuel cell unit 6 can consist of, for example, solid oxide fuel cells (SOFC) or molten carbonate fuel cells (MCFC) or other suitable fuel cell types. In the illustrated apparatus hydrogen, produced from, e.g. natural gas, is used as fuel. The natural gas is introduced into the apparatus in a pressurised state through feed line 1 via a heat exchanger 2, in which the fuel is heated by means of the heat of the exhaust gases. Subsequent to the heat exchanger there is a desulphuring unit 3, in which sulphur is removed from the fuel. Subsequent to the desulphuring unit 3, the natural gas is directed, depending on the configuration of the apparatus, into either a pre-reformer or reformer 4, in which the natural gas is turned into, among others, hydrogen. Water is used for assisting in the forming of hydrogen, with water being introduced into the apparatus in a pressurised state through inlet line 16 via heat exchanger 17, in which the water is vaporised by means of the heat of the exhaust gases. In the reformer 4 the hydrocarbons of the natural gas are transformed into hydrogen, methane and carbon dioxides using water vapour. In order to improve the efficiency of the operation of the apparatus, part of the exhaust gases of the anode side 7 is directed via heat exchanger 5 and the fan or compressor 13 to the inlet side of the reformer 4, whereby also carbon dioxide and the water vapour of the anode side 7 exhaust gases are mixed into the inlet flow. From the reformer 4 the fuel is directed via the said heat exchanger 5 to the anode side 7 of the fuel cell unit 6 formed by fuel cell stacks. The fuel cell stacks of the fuel cell unit 6 are formed by a number fuel cells compressed together so as to be in contact with each other, each fuel cell having an anode side 7, a cathode side 8 and an electrolyte 9 therebetween. In the figure the fuel cell stacks and their possible combinations are shown schematically as an assembly. The portion of the anode side 7 exhaust gases that is not recirculated is directed into an afterburner 14, in which the residual fuel is combusted and subsequent to which the exhaust gases are introduced via heat exchangers 17, 2 and 15 away from the apparatus.

Correspondingly, oxygen is fed to the cathode side 8 along with air by means of a fan or compressor 10, wherefrom air is directed via inlet line 11 to a heat exchanger 12, in which the incoming air is preheated by means of exhaust gases from the cathode side prior to being directed to the cathode side 8. The largest portion of the heat of the cathode side exhaust gases is used for preheating the air directed to the cathode side in the heat exchanger 12, into which the cathode side exhaust gases are directed. A smaller portion of the heat is directed further into the afterburner 14 with the exhaust gases and thus away from the apparatus, or directly away from the apparatus via, e.g. the heat exchanger 15.

FIG. 2 illustrates one solution according to the invention as applied to a fuel cell apparatus, such as an apparatus as described in FIG. 1. In the apparatus, a fuel cell unit 6 is provided with a fire-proof casing 18, surrounding the whole of the fuel cell unit 6. The inlets of fuel and air as well as the outlets of the exhaust gases are sealedly led through the walls of the casing 18 into the fuel cell unit 6. The casing 18 is dimensioned so as to be suitably larger on the inside than the fuel cell unit 6 so that a combustion space 19 for leaked fuel is provided between the inner walls of the casing 18 and the fuel cell unit 6, the combustion space surrounding the fuel cell stacks of the fuel cell unit 6 essentially in all directions.

Correspondingly, an exhaust gas inlet line 22 is connected to the outlet 20 of the afterburner 14 by its first end, the inlet line being connected to the combustion space 19 of the casing 18 by its other end. In the embodiment of FIG. 2 the inlet line is provided with a fan 21 or the like. The fan 21 is needed in cases where there is a need to compensate pressure loss of the combustion space. However, often the high pressure in the outlet of the afterburner is sufficient for causing a gas flow into the combustion space 19 and further therefrom. The apparatus additionally includes an outlet channel 23 or the like, the first end of which is in the combustion space 19 and which has been arranged to transport the exhaust gases 19 of the combustion space away from the apparatus either directly, via a heat exchanger or by directing the combustion gases again to the afterburner 14. The different outlet options are not shown in the figure.

According to the invention, hot exhaust gases containing excess oxygen are directed from the afterburner 14 along the inlet line 22 into the combustion space 19, in which the hot fuel leaked from the fuel cells is combined with oxygen and is safely combusted separated from other apparatuses and it is removed from the apparatus as exhaust gas. The exhaust gas containing excess oxygen is directed from the afterburner 14 into the combustion space 19 in such a state that the temperature of the exhaust gas is higher than the flash point of the leaked fuel, so that the leaked fuel with any hydrocarbons is combusted. Further, combustion of leaked gases is arranged to take place essentially adjacent the fuel cells of the fuel cell unit 6 for maintaining the fuel cells in a necessary temperature during the operation of the fuel cells.

Fuel cell stacks operating in high temperature, such as stacks formed of solid oxide fuel cells (SOFC) or molten carbonate fuel cells (MCFC) must be preheated to a temperature of about 450° C. during starting phase before they can be put under a load. Usually the preheating is carried out by means of electric resistors. The fuel cells provide electric power only after having been heated to their operation temperature, which is much higher than the preheating temperature, so the preheating can not be carried out by means of the electricity produced by the fuel cells themselves. In case there is not a sufficient external electric supply at the installation location, the preheating is difficult to carry out.

By means of a solution according to the invention, the preheating of the fuel cells can be carried out by directing at least some of the exhaust gas of the afterburner 14 to the combustion space 19 of the casing 18 surrounding the fuel cell unit 6. Thus, the exhaust gases of the afterburner 14 heat the fuel cells and the reaction can be started without an external electric supply for this purpose.

It is obvious to one skilled in the art that the invention is not limited to the above-mentioned example, but it can be varied within the following claims. Thus, for example, the construction of the apparatus and the construction components used can differ from those described in the above. It will also be obvious that instead of the gas from the afterburner, containing an excess of oxygen, for example cathode side discharge gas, can be considered to be introduced, the gas containing oxygen as well and being in a relatively high temperature.

It will as well be obvious to one skilled in the art that the circulation of the materials to be conveyed in the apparatus, such as fuel, exhaust gases and air, does not necessarily have to be as described in the above, but the circulation can be carried out by means of a number of ways and number of apparatus configurations.

It will be obvious to one skilled in the art that the solution according to the invention is not limited to be used only in connection with the said solid oxide fuel cells or molten carbonate fuel cells, but it is applicable for use with essentially all leak gases of all essentially fuel cells operating in high temperature.

It is additionally obvious to one skilled in the art that in addition to said natural gas other fuels applicable to be used in fuel cells can be used as fuel. Accordingly, another suitable substance can be used instead of hydrogen.

1-8. (canceled)

9. An arrangement for processing the leakage gases of fuel cells in a fuel cell apparatus, the fuel cell apparatus comprising at least a fuel cell unit, the fuel cells of which include an anode side and a cathode side and in which fuel cell apparatus there is at least a fuel inlet to the anode side and an inlet for oxygen-containing fuel into the cathode side, wherein the fuel cell unit is arranged inside a combustion space of a casing surrounding it, the combustion space being provided with an opening for introducing oxygen-containing gas thereto.

10. An arrangement according to claim 9, wherein the fuel cell apparatus is provided with an afterburner for combusting the exhaust gases of the anode and cathode sides, whereby the inlet is an inlet line arranged between the afterburner and the combustion space for directing exhaust gas containing excess oxygen from the afterburner into the combustion space.

11. An arrangement according to claim 10, wherein the inlet line between the afterburner and the combustion space is provided with a fan or the like.

12. An arrangement according to claim 9, wherein an outlet channel is arranged into the combustion space for transporting the exhaust gases of the combustion space away from the fuel cell apparatus.

13. An arrangement according to claim 9, wherein in the combustion space the combustion of leakage gases is arranged to take place adjacent the fuel cells for maintaining the fuel cells in a suitable temperature during the operation of the fuel cells.

14. An arrangement according claim 9, wherein at least a portion of the exhaust gases of the afterburner are arranged to be directed into the combustion space of the casing surrounding the fuel cell unit in the starting phase of the fuel cell apparatus for preheating the fuel cells into a temperature allowing the reaction.

15. A method of processing the leakage gases of fuel cells in a fuel cell apparatus, the fuel cell apparatus comprising at least a fuel cell unit, the fuel cells of which include an anode side and a cathode side and in which fuel cell apparatus there is at least a fuel inlet to the anode side and an inlet for oxygen-containing fuel into the cathode side, in which fuel is introduced into the anode side during operation of the fuel cell apparatus and oxygen-containing gas is introduced to the cathode side, wherein the oxygen-containing gas is introduced into a combustion space surrounding the fuel cell unit.

16. A method according to claim 15, wherein the fuel cell apparatus includes an afterburner for combusting the exhaust gases of the anode and cathode sides, whereby exhaust gas containing excess oxygen is introduced from the afterburner via the inlet line to the combustion space surrounding the fuel cell unit.

17. Fuel cell apparatus comprising:
a fuel cell unit having an anode side and a cathode side,
a fuel supply inlet connected to the anode side of the fuel cell unit for delivering fuel to the anode side,
an oxygen supply inlet connected to the cathode side of the fuel cell unit for delivering oxygen to the cathode side,
a casing in which the fuel cell unit is located, the casing defining a combustion space for receiving leakage gases from the fuel cell unit, and
a gas supply inlet for introducing oxygen into the combustion space.

18. Fuel cell apparatus according to claim 17, wherein the oxygen supply inlet is connected to atmosphere for delivering air to the cathode side of the fuel cell unit.

19. Fuel cell apparatus according to claim 17, wherein the cathode side of the fuel cell unit has a gas exhaust outlet and the gas supply inlet is connected to the gas exhaust outlet for introducing exhaust gas from the cathode side of the fuel cell unit into the combustion space.

20. Fuel cell apparatus according to claim 19, wherein the anode side of the fuel cell unit has a gas exhaust outlet, the apparatus comprises an afterburner, the gas exhaust outlet of the anode side of the fuel cell unit is connected to the afterburner for combusting excess fuel present in exhaust gas from the anode side of the fuel cell unit, the exhaust gas outlet of the cathode side of the fuel cell unit is connected to the afterburner for supplying oxygen to the afterburner, and the afterburner has an exhaust gas outlet that is connected to the gas supply inlet for introducing exhaust gas from the afterburner into the combustion space.

21. Fuel cell apparatus according to claim 20, wherein the oxygen supply inlet is connected to atmosphere for delivering air to the cathode side of the fuel cell unit.

22. Fuel cell apparatus according to claim 17, wherein the fuel cell unit includes at least one fuel cell stack.

23. A method of operating a fuel cell apparatus that includes a fuel cell unit, said method comprising:
feeding fuel to the anode side of the fuel cell unit and feeding oxygen to the cathode side of the fuel cell unit,
collecting leakage gases from the fuel cell unit in a combustion space surrounding the fuel cell unit,
introducing oxygen into the combustion space, and
combusting the leakage gases in the combustion space.

24. A method according to claim 23, comprising feeding air to the cathode side of the fuel cell unit.

25. A method according to claim 23, comprising introducing exhaust gas from the cathode side of the fuel cell unit into the combustion space.

26. A method according to claim 23, comprising:
delivering exhaust gas from the anode side of the fuel cell unit to an afterburner,
delivering exhaust gas from the cathode side of the fuel cell unit to the afterburner to support combustion of excess fuel present in the exhaust gas from the anode side of the fuel cell unit, and
introducing exhaust gas from the afterburner into the combustion space.

27. A method according to claim 26, comprising feeding air to the cathode side of the fuel cell unit.
